(19) United States
(12) Patent Application Publication
(10) Pub. No.: US 2009/0317039 A1
(43) Pub. Date: Dec. 24, 2009

(54) Fiber optic cable having armor with easy access features

(76) Inventors: Bradley J. Blazer, Granite Falls, NC (US); Michael J. Gimblet, Conover, NC (US); Julian L. Greenwood III, Hickory, NC (US); Joseph N. Henkel, Lafayette, CO (US); Reginald Roberts, Taylorsville, NC (US)

Correspondence Address: CORNING INCORPORATED, INTELLECTUAL PROPERTY DEPARTMENT, SP-TI-3-1, CORNING, NY, 14831, US

(21) Appl. No.: 12/214,461

(22) Filed: Jun. 19, 2008

(51) Int. Cl. G02B 6/44

(52) U.S. Cl. 385/107

(57) ABSTRACT

The present disclosure is generally directed to a fiber optic cable including a cable core and an armor surrounding the cable core. The cable core has at least one optical fiber and the armor includes one or more lines of scoring extending along a longitudinal length of the armor, thereby creating a dedicated location for the craft to open the armor to access the cable core and optical fibers therein.

### BACKGROUND OF THE INVENTION

1. Field of the Invention

The present invention relates generally to fiber optic cable designs that include features for opening the armor of the cables, thereby allowing the craftsman quick and easy access to the optical fibers within the cable.

2. Technical Background

Fiber optic cables are used to transmit data in indoor and outdoor environments. Various types of fiber optic cable designs have been proposed. For example, outdoor long-haul applications can use loose-tube cables in which one or more optical fibers are disposed within a plastic buffer tube that can be filled with a thixotropic material such as a grease or gel. Buffer tubes for outdoor cables can serve several functions such as protecting the optical fiber(s) therein along with segregating and grouping the optical fiber(s). Generally speaking, outdoor cables are robust designs intended to protect the optical fibers.

It is common for outdoor cables to include an armor for protection from rodent attack, crush, and/or for providing a robust cable design. The armor is typically formed from a tape such as a metallic, e.g. steel, or nonmetallic, e.g. plastic, or combinations thereof. It can be difficult and time consuming for the craft to remove the armor to access the optical fibers within the fiber optic cable. Additionally, injury can result if the craftsman does not exercise care when opening the armor to access the optical fibers.

Tubeless cables have been proposed for outdoor applications in which one or more fibers are disposed within a cable core without a buffer tube for housing and protecting the optical fibers. Generally speaking, the buffer tube inhibits damage to the optical fibers when the craft opens the armor to access the optical fibers in the cable core. Consequently, tubeless designs have been slow to gain acceptance in the market, at least in part because of perceived concern of inadvertently damaging the optical fibers when removing the armor. By way of illustration, optical fibers may be inadvertently cut or nicked by the craft when attempting to open of the armor to access the optical fibers within a tubeless cable design.

Accordingly, the present invention is directed to fiber optic cable designs, both including buffer tubes and tubeless configurations that substantially obviates one or more of the problems and disadvantages opening the armor of fiber optic cables. Additional features and advantages of the invention will be set forth in the description that follows, and in part will be apparent from the description, or may be learned by practice of the invention. The objectives and other advantages of the invention will be realized and attained by the apparatus and process particularly pointed out in the written description and claims, as well as the appended drawings.

### SUMMARY OF THE INVENTION

The present disclosure is generally directed to a fiber optic cable including a cable core and an armor surrounding the cable core. The cable core has at least one optical fiber and the armor includes one or more lines of scoring extending along a longitudinal length of the armor for providing the craft with a dedicated location for opening the armor, thereby providing an easy and safe access by greatly reducing and/or eliminating the risk of damaging the optical fibers during the access procedure.

In another embodiment of the present disclosure, a fiber optic cable including a cable core and an armor surrounding the cable core is described. The armor includes at least one line of scoring extending along a longitudinal length of the metallic armor wherein the at least one line of scoring has a depth between about 5% to about 90% of a thickness of the armor.

It is to be understood that both the foregoing general description and the following detailed description present embodiments of the invention, and are intended to provide an overview or framework for understanding the nature and character of the invention as it is claimed. The accompanying drawings are included to provide a further understanding of the invention, and are incorporated into and constitute a part of this specification. The drawings illustrate various embodiments of the invention, and together with the description serve to explain the principles and operation of the invention.

### BRIEF DESCRIPTION OF THE FIGURES

FIG. 1 is a perspective view of a fiber optic cable according to certain aspects of the present invention:

FIG. 2 is a cross-sectional view of the fiber optic cable of FIG. 1;

FIG. 3 is a perspective view of a fiber optic cable showing separation of a line of scoring according to certain aspects of the present invention;

FIG. 4 is a cross-sectional view of a fiber optic cable according to certain aspects of the present invention;

FIG. 5 is a perspective view of a fiber optic cable according to certain aspects of the present invention;

FIG. 6 is a cross-sectional view of a fiber optic cable according to certain aspects of the present invention;

FIG. 7 is a perspective view of a fiber optic cable according to certain aspects of the present invention;

FIG. 8 is a perspective view of another fiber optic cable according to certain aspects of the present invention;

FIG. 9 is a perspective view of a fiber optic cable including the armor of FIG. 8 according to certain aspects of the present invention;

FIG. 10 is a perspective view of a fiber optic cable including a ripcord according to certain aspects of the present invention;

FIG. 10A is a detail bubble showing dimensions of explanatory armor; and

FIG. 11 is a perspective view of a fiber optic cable including a discontinuous line of scoring according to certain aspects of the present invention.

### DETAILED DESCRIPTION OF PREFERRED EMBODIMENTS

Reference will now be made in detail to the preferred embodiments of the present invention, examples of which are illustrated in the accompanying drawings. Whenever possible, like reference numbers will be used to refer to like components or parts. Examples of fiber optic cables according to various aspects of the present invention are disclosed in the figures, as described below. The various disclosed aspects of the embodiments below may be combined or modified to create further embodiments of the invention.

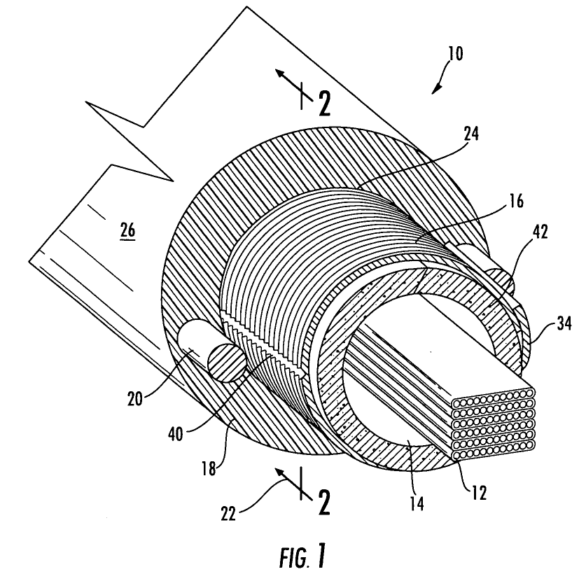

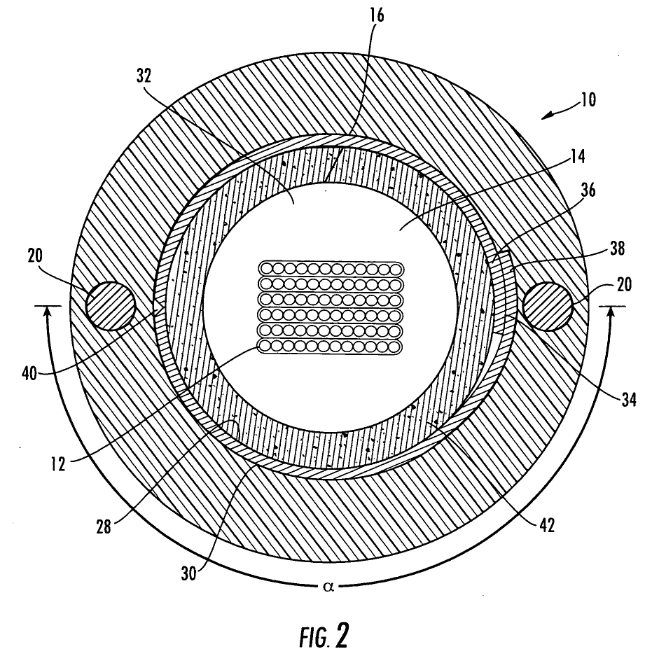

FIGS. 1 and 2 depict a first example of a fiber optic cable 10 including at least one optical fiber 12 generally disposed within a cavity 14 of an armor 16 that extends in a substantially longitudinal direction. Fiber optic cable 10 can also include a cable jacket 18 and/or at least one strength member 20. As depicted, fiber optic cable 10 is a tubeless configuration, meaning that the optical fibers are disposed in an outer cable jacket, but no buffer tube is disposed between the optical fibers and the cable jacket. Armor 16 includes one or more lines of scoring 40 as discussed in more detail below, thereby providing the craft with one or more dedicated locations for opening the same to access optical fiber(s) 12 within the fiber optic cable. The fiber optic cables disclosed herein are advantageous because they provide quick and reliable access to the optical fibers therein since the armor is easily opened by the craft. This is especially advantageous in tubeless fiber optic cables where the optical fibers are not further protected by a buffer tube since the craft does not have to create an access location in the armor. In other words, the scoring of the armor greatly reduces and/or eliminates the risk of damaging the optical fibers during the access procedure. Of course, the concepts of the invention may be used with any suitable type of fiber optic cable such as loose tube, slotted core, non-round designs, and the like.

As depicted, optical fiber 12 of fiber optic cable 10 is a portion of a fiber optic ribbon (not numbered) as known in the art. As shown, the fiber optic ribbon is a portion of a ribbon stack (not numbered), but optical fibers 12 can have any suitable configuration. By way of example, optical fibers can be bundled together, loosely disposed, tight-buffered, buffered, or have other suitable configurations. Additionally, optical fibers 12 can be single mode, multimode, erbium-doped, plastic, polarization-maintaining, photonic, specialty, or any other suitable optical waveguide. Individual fibers or groups of fibers can also include marking indicia for identification such as an ink layer, one or more binding threads or the like for ready identification and/or separation by the craft.

Additionally, fiber optic cables can include any suitable cable components as desired. For instance, other cable components may be utilized within cavity 14 such as between optical fibers 12 and armor 16. For example, cavity 14 can optionally include a water-blocking component such as a thixotropic material (i.e., grease or gel) and/or a water-swellable component(s) such as a yarn or tape, a foam-tape such as a water-swellable foam tape, or other suitable cable components. Further, cavity 14 can be empty other than the optical fibers. As depicted, fiber optic cable 10 includes a water-swellable tape 42 generally disposed about the ribbon stack (not numbered). In other embodiments, intermittent filling materials can be used within cavity 14, for instance, the thixotropic material, foam material, or other suitable material is intermittently disposed within the fiber optic cable so as to effectively inhibit the migration of water therein.

Referring again to FIGS. 1 and 2, cable jacket 18 extends along the longitudinal direction 22 and generally surrounds armor 16. Cable jacket 18 generally surrounds armor 16 for providing environmental protection. Cable jacket 18 can be formed by extrusion of a material such as polyethylene (PE), polyvinyl chloride (PVC), or any other suitable polymer or blend. Cable jacket 18 can also include suitable additives such as for improving flame-retardant properties to achieve a plenum or riser rating or for processing purposes.

As depicted, cable jacket 18 includes strength members 20 at least partially disposed therein, thereby coupling the strength members 20 with cable jacket 18. Specifically, fiber optic cable 10 is shown with two strength members 20 disposed about 180 degrees apart for imparting a preferential bend characteristic to fiber optic cable 10. Strength members 20 extend along the longitudinal direction to provide tensile strength to fiber optic cable 10, which inhibits the transfer of tensile forces to optical fibers 12. Additionally, strength members 20 can also provide anti-buckling characteristics to the cable. In a tubeless fiber optic cable, strength members 20 can be steel wires that provide an anti-buckling characteristic. However, strength members 20 can be made of various materials including other conductive materials such as a copper clad steel wire, a dielectric material such as a glass-reinforced plastic (GRP), a semiconductor material, or suitable combinations thereof.

As shown, armor 16 extends along the longitudinal direction 22 of fiber optic cable 10. Armor 16 has an inner surface 28 that faces a cable core 32 and an outer surface 30 on the opposite side of armor 16 that faces cable jacket 18. In fiber optic cable 10, cable core 32 includes the ribbon stack (not numbered) and water-swellable tape 42. However, cable core 32 can have other suitable configuration and/or components such as one or more buffer tubes, a slotted core, strength members, etc. Armor 16 is preferably formed from an armor tape such as dielectric or conductive material such as steel or the like that may be corrugated or flat as desired. In a preferred embodiment, armor 16 is a corrugated metallic tape that includes a coating (not shown) for inhibiting corrosion. Armor 16 preferably is mechanically robust enough to withstand penetration by foreign objects, such as attack by rodents and to inhibit the migration of moisture into cable core 32.

Armor 16 depicts a seam 34 of the overlap type which is formed by a non-offset layer 36 and offset layer 38, but a butt seam is also possible. As shown in FIGS. 1 and 2, offset layer 38 is located radially outside of non-offset layer 36. The ends of armor can be fixed together in any suitable manner, such as by an adhesive, weld, or the like, which may also aid in sealing. Additionally, seam 34 may have a seam guard thereover for inhibiting the zippering of cable jacket 18 due to any sharp edges that may cut cable jacket 18 when the cable is flexed.

Armor 16 includes a line of scoring 40 disposed generally in the longitudinal direction for providing the craft with a dedicated access location for opening armor 16 and gaining entry into cable core 32. As used herein, the term “scoring” refers to cuts or grooves formed in at least one surface of the armor 16 for reducing the thickness relative to the remainder of the armor, thereby creating a dedicated access location that has a weakened portion. Scoring should not be confused with corrugation, which deforms the armor but does not reduce the thickness of the armor for providing a dedicated access location. Instead, corrugation of the armor aids in the flexibility of the armor/fiber optic cable.

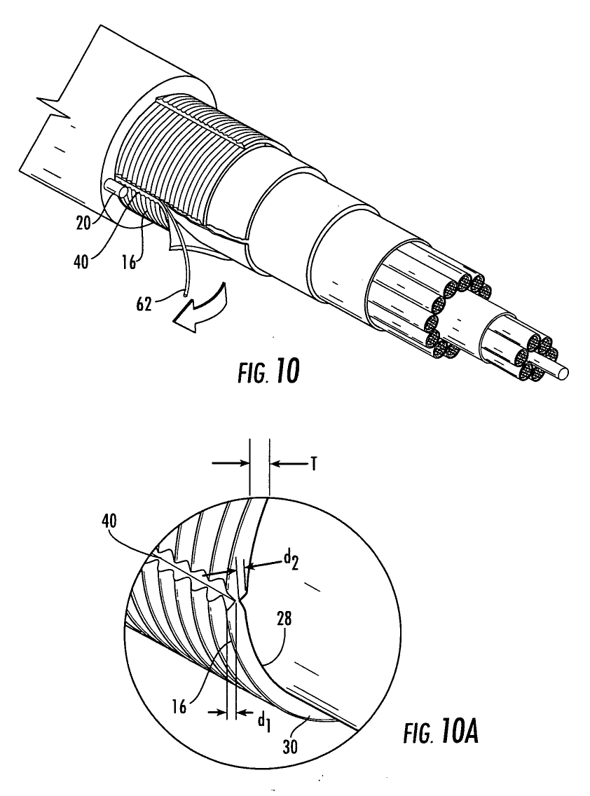

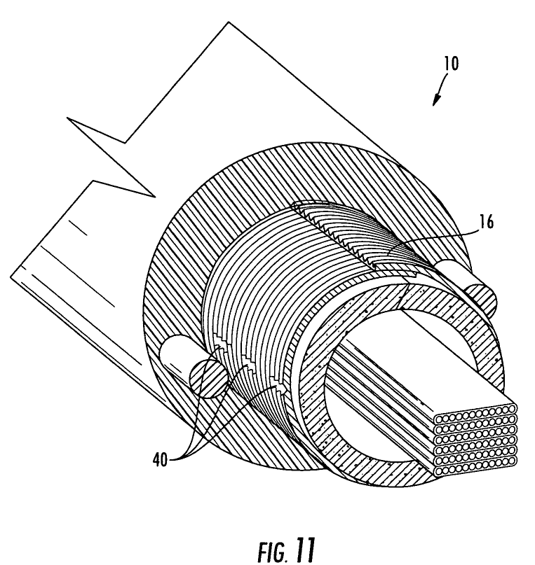

Line of scoring 40 of armor 16 may be formed along the inner surface 28, outer surface 30, or both surfaces as depicted in FIG. 10A. Preferred embodiments have the line of scoring on outer surface 30 so that its location is visible to the craft. Additionally, armor 16 can have multiple lines of scoring. Moreover, a depth d of the line of scoring can vary between about 5% to about 90% of a thickness T of the armor, more preferably the depth d is between about 20% and 70% of the thickness T. Additionally, if the lines of scoring on the inner surface 28 and the outer surface 30 are aligned as shown in FIG. 10A the depths are added such as adding a depth d₁ and a depth d₂ to determine the effective depth. However, the term “scoring” can also include perforations that extend from the outer surface 30 to the inner surface 28 of the armor 16 in an intermittent fashion; however, this could create a leak path into the cable core. Generally speaking, lines of scoring weaken the armor in defined areas, thereby providing the craft easier access to cable core 32 and optical fiber(s) 12 therein. Armor having lines of scoring provides the craft with a defined access location for tearing and/or bending of armor 16 to easily open the same, instead of trying to open the same without a defined access location. Line of scoring 40 can be a straight line or a curved line and can extend in any direction along armor 16, including longitudinally along the length, or laterally along the width, or combinations thereof. Line of scoring can also be continuous as shown in FIG. 1 or intermittent as shown in FIG. 11 for suitable lengths.

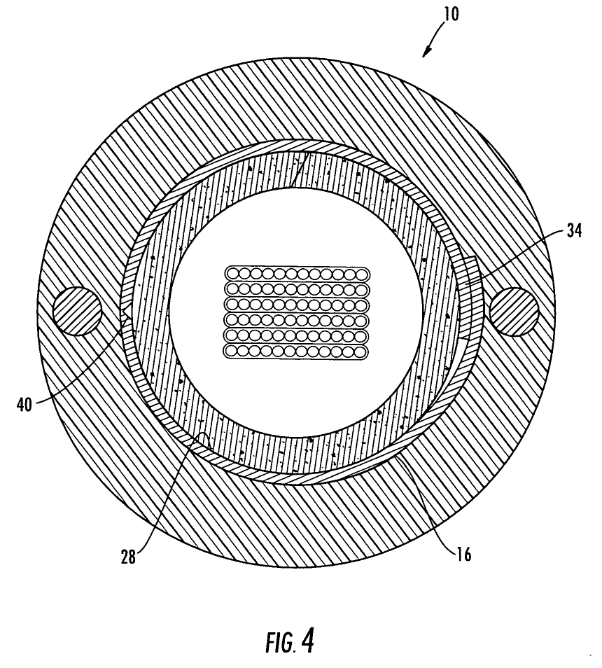

As shown in FIGS. 1 and 2, line of scoring 40 extends longitudinally along outer surface 30 of armor 16 with the depth d being greater than 30 percent of the thickness T of armor 16 such as 50 percent or greater. Line of scoring 40 is disposed at a predetermined angle α from seam 34 (i.e., angled apart at an angle α) such as between about 10 degrees and about 180 degrees. As depicted in FIG. 2, angle α is about 180 degrees from seam 34 (i.e., on the opposite side from the seam) and generally adjacent to strength member 20, but other angles and/or configurations are possible such as about 90 degrees from the strength member. By way of example, FIG. 4 depicts a line of scoring 40 extending longitudinally along inner surface 28 of armor 16 and is positioned at angle α that is about 180 degrees from seam 34. Although, FIG. 4 provides a similar defined access location for opening the armor, the line of scoring would not be as visible to the craft since it is disposed on the inner surface 28 of armor 16.

The concepts of the present invention are advantageous because the craftsman can easily open and/or remove a predetermined section of armor 16 to access the optical fibers with the cable core, while greatly reducing or eliminating the possibility of damaging the optical fibers or injury. This is especially true for tubeless fiber optic cables that do not have further protection for the optical fibers. Moreover, tubeless fiber optic cables have the additional benefit of reduced size and expense because of the omission of the buffer tube while still reducing the risk of optical fiber damage.

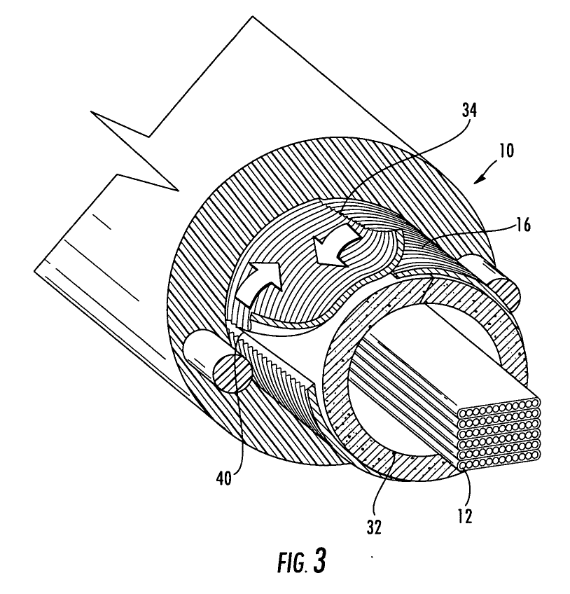

Specifically, FIG. 3 illustrates the process of opening armor 16 for accessing optical fibers 12 of fiber optic cable 10. First, a portion of cable jacket 18 is removed to expose armor 16 such as by ring cutting the cable jacket at two spaced apart locations and then making a longitudinal cut between the two spaced apart ring cuts as known to the craft. Thereafter, the craft can locate the line of scoring on armor 16 and can use an appropriate tool to open (e.g., separate) armor 16 over a portion of line of scoring 40 and/or seam 34. As shown in FIG. 3, separation over a portion of line of scoring 40 provides for easy separation of armor 16 into two portions to allow the craft to pull back and/or remove a portion of armor 16 between the line of scoring 40 and seam 34, thereby permitting access to optical fiber(s) 12 within cable core 32.

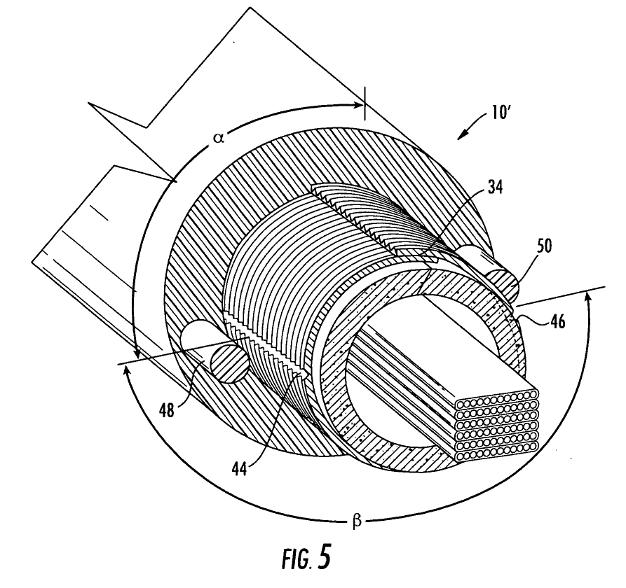

As stated above, armor 16 can include more than one line of scoring at suitable locations. By way of example, FIG. 5 depicts a fiber optic cable 10′ having multiple lines of scoring that is similar to fiber optic cable 10. Specifically, armor 16′ includes a first line of scoring 44 and a second line of scoring 46 that are positioned with an angle β therebetween. Specifically, angle β is about 180 degrees so that the first line of scoring 44 is generally adjacent to first strength member 48 and the second line of scoring 46 is generally adjacent to second strength member 50. Moreover, first line of scoring 44 and second line of scoring 46 are each angled about 90 degrees from seam 34 (i.e., the angle α is about 90 degrees for each line of scoring). In other embodiments, the line of scoring can be angled apart at other suitable angles. For instance, the first line of scoring is angled apart from the second line of scoring by an angle that is between about 5 degrees to about 180 degrees. Simply stated, lines of scoring can be spaced at a width sufficient to allow access to cable core 32 and optical fiber 12 such as creating a tab in the armor for removal.

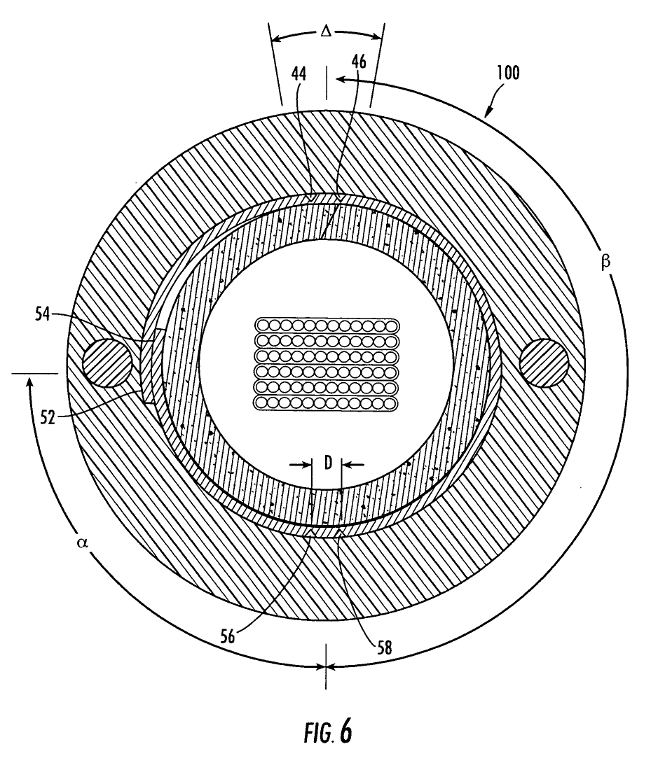

FIG. 6 depicts a fiber optic cable 100 that is similar to fiber optic cable 10, but allows for opening the armor by peeling a portion of the armor like a tab. Fiber optic cable 100 includes armor having multiple sets of lines of scoring that are positioned at an angle α from a seam 54 of armor 16. Moreover, the first set of scoring and the second set of scoring are positioned at angle β therebetween. As shown, angle α is about 90 degrees (i.e., between the seam 54 and respective sets of scoring), but other angles are possible such as being angled apart by 10 degrees or more. In this example, angle β is about 180 degrees, but other suitable angles such as between 20 degrees and 330 degrees are possible for angle β. A first set (not numbered) of scoring includes a first line of scoring 44 and a second line of scoring 46 that are spaced apart by a suitable distance D such as at least 2 millimeter arc length, but other suitable distances D are possible. A minimum distance D is required so that the tab does not break when the craft pulls on the same when opening. Distance D may depend on the material of the armor, depth of the line of scoring, thickness of the armor, and/or diameter of the armor. Likewise, a second set of scoring (not numbered) includes a third line of scoring 56 and a fourth line of scoring 58 having a similar spacing as the first set. Further, the distance between the first line of scoring 44 and the second line of scoring 46 may be specified by being angled apart at an angle Δ instead of a distance D. By way of example, angle Δ is less than or equal to about 10 degrees or less to create the tab portion of the armor, likewise the angle Δ between the third line of scoring 56 and fourth line of scoring 58 can be similar. However, other suitable values for angle Δ are possible such as 15 degrees or less. Consequently, the craft can remove (i.e., peel back) a portion of the armor such as a 2-10 millimeter wide tab of armor that is disposed between the lines of scoring, thereby creating a pull tab arrangement on the armor. In this embodiment, the two sets of scoring are disposed on opposite sides of the armor to make opening of the armor quick, easy, and reliable for the craft. Of course, one or more sets of scoring may be placed at any desired location on the armor.

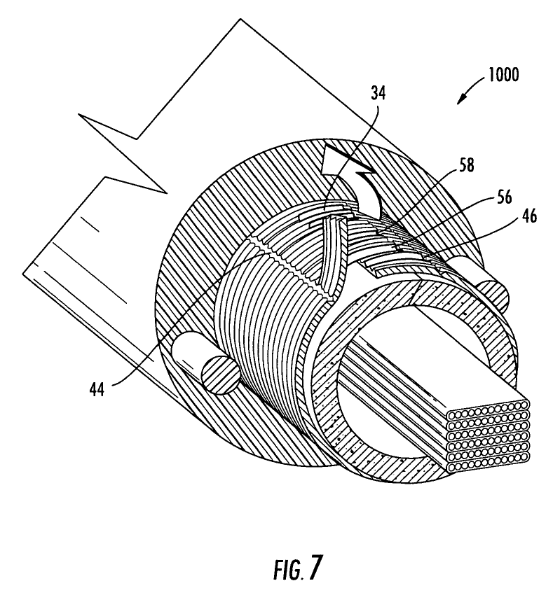

FIG. 7 depicts another fiber optic cable 1000 that is similar to fiber optic cable 10. Fiber optic cable 1000 includes armor having multiple lines of scoring. First line of scoring 44 and second line of scoring 46 are positioned longitudinally along armor 16, each being generally adjacent to seam 34. Additionally, a first start scoring 56 and a second start scoring 58 (hereinafter start scoring) are positioned laterally along the width of armor 16 such that they are generally parallel and extend from seam 34 towards first line of scoring 44. Start scoring can extend from about 1% to about 100% of the distance between a seam and a longitudinal score line such as first line of scoring 44. Start scoring can be positioned along armor 16 in a repeating pattern along the length of the armor 16 as desired. As shown in FIG. 7, the start scoring 56 and 58 allow for armor 16 to be separated to open seam 34 and assist in further separation along longitudinal score lines 44 and 46 by bending back as indicated by the arrow. By way of example, start scoring lines are spaced along the length of the armor at a desired spacing such as 300 millimeters.

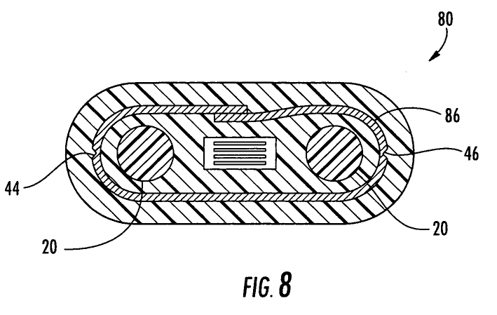

Additionally, the concepts of the present invention are suitable for use with fiber optic cables having a non-round cable cross-section. Illustratively, FIG. 8 depicts a fiber optic cable 80 having armor with lines of scoring. More specifically, fiber optic cable 80 is a tubeless configuration having a generally flat profile where the ribbon stack (not numbered and ribbons are represented by lines) is not stranded within the cavity of the cable jacket. Specifically, armor 86 is disposed about the cavity housing the ribbon stack and strength members 20. First line of scoring 44 and second line of scoring 46 are disposed adjacent to respective strength members 20, thereby providing two dedicated locations for opening the armor after it is exposed.

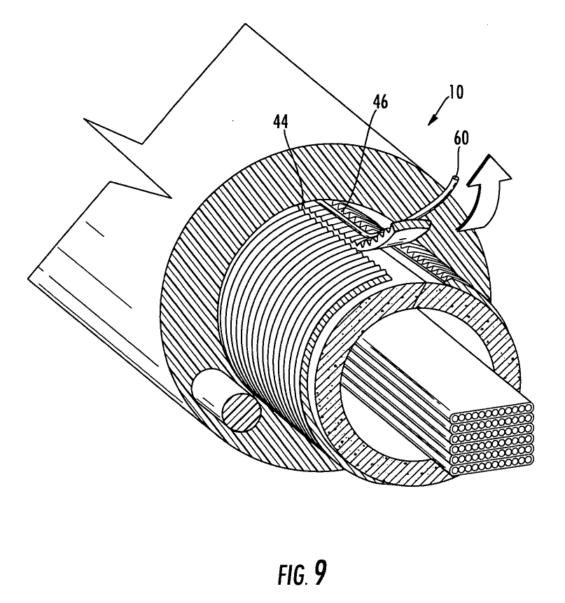

Referring to FIG. 9, a wire 60 or other similar component can be joined with armor 16 for aiding in the opening of the armor. Wire 60 can be any suitable material such as steel or the like so long as it has a suitable strength and size. Wire 60 is attached to a surface of armor 16 between first line of scoring 44 and second line of scoring so that pulling on wire 60 opens a portion of the armor in a pull tab arrangement. Wire 60 can be joined to armor 16 by any suitable method including adhesive, welding, or the like. In other embodiments, the wire is integrally formed with armor 16. As shown by the arrow, the craft can remove the cable jacket then apply sufficient force to the wire 60 (a portion of the wire may first require cutting), thereby separating the armor 16 at a portion of one or more lines of a line of scoring 44, 46 for accessing the cable core.

Similarly, FIG. 10 shows a ripcord 62 that can be used in connection with the concepts of the present invention. One or more ripcords 62 can be disposed under (i.e., radially inward of the armor) armor 16 near the line of scoring 40 for aiding entry into the cable core for accessing the optical fibers. In particular, ripcord 62 is designed to help separate a portion of line of scoring 40 by cutting through line of scoring 40. Ripcord 62 can be made of aramid fibers or any other suitable material. Ripcord 62 is operative to, upon application of sufficient pulling force, to rip through the armor at the line of scoring. Various orientations of one or more ripcords 62 are possible relative to the armor 16 and one or more lines of scoring 40 according to the concepts of the present invention.

Lines of scoring can be created in armor using appropriate tooling or equipment. By way of example, a cobalt steel machine bit pressed into the armor with the desired force has been found suitable for creating suitable lines of scoring. In certain embodiments, the lines of scoring can be created prior to the armor entering a corrugator, but forming the score may be possible during or after corrugation. Moreover, the lines of scoring may be formed at the time of manufacturing the armor or on-line during the manufacture of the fiber optic cable. Lines of scoring can also be created using a profiled roller, cutter, or laser. However, any suitable method for creating the fiber optic cables of the present disclosure is contemplated for use with the present disclosure.

Many modifications and other embodiments of the present invention, within the scope of the appended claims, will become apparent to a skilled artisan. For example, many other shapes and types of fiber optical cables besides round are possible in connection with the present disclosure. Therefore, it is to be understood that the invention is not to be limited to the specific embodiments disclosed herein and that modifications and other embodiments may be made within the scope of the appended claims. Although specific terms are employed herein, they are used in a generic and descriptive sense only and not for purposes of limitation.

1. A fiber optic cable comprising:
a cable core having at least one optical fiber;
a metallic armor surrounding the cable core, the metallic armor comprising at least one line of scoring extending along a longitudinal length of the metallic armor, wherein upon application of sufficient force the metallic armor is separated over a portion of the at least one line of scoring to facilitate access to the at least one optical fiber; and
a polymeric cable jacket surrounding an exterior surface of the metallic armor.

2. The fiber optic cable of claim 1, wherein the at least one line of scoring is disposed on an inner surface of the metallic armor.

3. The fiber optic cable of claim 1, wherein the at least one line of scoring is disposed on an outer surface of the metallic armor.

4. The fiber optic cable of claim 1, wherein the at least one line of scoring comprises more than one line of scoring.

5. The fiber optic cable of claim 1, wherein the at least one line of scoring comprises a first line of scoring and a second line of scoring, the first line of scoring and the second line of scoring being angled apart by about 5 degrees to about 180 degrees.

6. The fiber optic cable of claim 1, wherein the at least one line of scoring comprises a first line of scoring and a second line of scoring, and wherein the first line of scoring and the second line of scoring are angled apart by about 10 degrees or less.

7. The fiber optic cable of claim 6, wherein the at least one line of scoring further comprises a third line of scoring and a fourth line of scoring, the third line of scoring and the fourth line of scoring being angled apart by about 10 degrees or less.

8. The fiber optic cable of claim 1, wherein the at least one line of scoring is located on the opposite side of at least one seam of the metallic armor.

9. The fiber optic cable of claim 1, wherein the metallic armor further comprises a wire attached to the metallic armor.

10. The fiber optic cable of claim 1, further comprising a ripcord, the ripcord being disposed radially inward of the metallic armor.

11. The fiber optic cable of claim 1, wherein the at least one line of scoring comprises a first line of scoring and a second line of scoring, the first line of scoring and the second line of scoring being angled apart by about 180 degrees.

12. The fiber optic cable of claim 1, wherein the metallic armor is corrugated.

13. The fiber optic cable of claim 1, wherein the at least one line of scoring is discontinuous.

14. A fiber optic cable comprising:
a cable core having at least one optical fiber;
a metallic armor disposed about a portion of the cable core, the metallic armor comprising at least one line of scoring extending along a longitudinal length of the metallic armor, wherein the at least one line of scoring has a depth between about 5% to about 90% of a thickness of the metallic armor, wherein upon application of sufficient force the metallic armor is separated over a portion of the at least one line of scoring to facilitate access to the at least one optical fiber; and
a polymeric cable jacket surrounding an exterior surface of the metallic armor.

15. The fiber optic cable of claim 14, wherein the at least one line of scoring is disposed on an inner surface of the metallic armor or an outer surface of the metallic armor.

16. A fiber optic cable comprising:
a cable core having at least one optical fiber;
an armor surrounding the cable core, the armor comprising at least one line of scoring extending along a longitudinal length of the armor, wherein upon application of sufficient force the armor is separated over a portion of the at least one line of scoring to facilitate access to the at least one optical fiber; and
a polymeric cable jacket surrounding an exterior surface of the metallic armor.

17. (canceled)

18. The fiber optic cable of claim 28, wherein the at least one line of scoring is disposed on an inner surface of the armor or an outer surface of the armor.

19. The fiber optic cable of claim 28, wherein the at least one line of scoring has a depth from between about 5% to about 90% of a thickness of the metallic armor.

20. The fiber optic cable of claim 1, wherein the cable jacket abuts the outer surface of the metallic armor.

21. The fiber optic cable of claim 1, further comprising at least one strength member disposed within the cable jacket.

22. The fiber optic cable of claim 21, further comprising a water swellable element disposed within and abutting an interior surface of the metallic armor.

23. The fiber optic cable of claim 21, wherein the metallic armor has a seam extending along a length of the armor.

24. The fiber optic cable of claim 14, wherein the metallic armor has a seam extending along a length of the armor.

25. The fiber optic cable of claim 24, wherein the cable jacket abuts the outer surface of the metallic armor.

26. The fiber optic cable of claim 25, further comprising a water swellable element disposed within and abutting an interior surface of the metallic armor.

27. The fiber optic cable of claim 24, further comprising at least one strength member disposed within the cable jacket.

28. The fiber optic cable of claim 16, wherein the armor has a seam extending along a length of the armor.

29. The fiber optic cable of claim 28, further comprising a water swellable element disposed within and abutting an interior surface of the armor.

30. The fiber optic cable of claim 28, wherein the cable jacket abuts the outer surface of the armor.

31. The fiber optic cable of claim 28, further comprising at least one strength member disposed within the cable jacket.

32. The fiber optic cable of claim 28, wherein the armor comprises a first line of scoring and a second line of scoring, the first line of scoring and the second line of scoring being angled apart from one another.
